(19) United States
(12) Patent Application Publication
(10) Pub. No.: US 2023/0387536 A1
(43) Pub. Date: Nov. 30, 2023

(54) RAIL-MOUNTED BATTERY CARRIER TRAY

(71) Applicant: STEWART & STEVENSON LLC, Houston, TX (US)

(72) Inventors: Ryan LOOFS, Cedar Park, TX (US); Michael WARHUS, Cedar Park, TX (US); Michael BECK, Cedar Park, TX (US); Michael THOMPSON, Cedar Park, TX (US)

(21) Appl. No.: 18/142,251

(22) Filed: May 2, 2023

Related U.S. Application Data
(60) Provisional application No. 63/347,054, filed on May 31, 2022.

(51) Int. Cl. H01M 50/262; H01M 50/296; H01M 10/6556; H01M 10/6568; H01M 50/512; H01M 50/51; H01M 10/613

(52) U.S. Cl. CPC H01M 50/262; H01M 50/296; H01M 10/6556; H01M 10/6568; H01M 50/512; H01M 50/51; H01M 10/613

(57) ABSTRACT

A battery group includes a carrier tray, battery module, and set of output terminals. The carrier tray includes an upper rail mount adapted to be received by a mounting bracket. The battery module is coupled to the carrier tray. The output terminals are operatively coupled to terminals of the battery module, the output terminals positioned on a rear face of the carrier tray. The carrier tray and battery module are adapted to be slidingly received by a cabinet or other enclosure such that the output terminals are engaged to an electrical system of the cabinet or other enclosure by sliding the battery group fully into the cabinet or other enclosure.

### CROSS-REFERENCE TO RELATED APPLICATIONS

This application is a nonprovisional application which claims priority from U.S. provisional application No. 63/347,054, filed May 31, 2022, which is incorporated by reference herein in its entirety.

### TECHNICAL FIELD/FIELD OF THE DISCLOSURE

The present disclosure relates generally to energy storage, and specifically to enclosures for battery systems.

### BACKGROUND OF THE DISCLOSURE

Battery systems, especially when installed in rugged or otherwise harsh environments, typically include cooling systems as well as the electrical connections to the battery itself. Servicing of such systems often requires the electrical cables and coolant lines to be removed by hand each time access to the battery is needed. Additionally, cooling systems may need to be depressurized before servicing, increasing complexity and time required to perform service or maintenance of the battery.

### SUMMARY

The present disclosure provides for a battery group. The battery group includes a carrier tray, the carrier tray including an upper rail mount, the upper rail mount adapted to be received by a mounting bracket. The battery group includes a battery module, the battery module coupled to the carrier tray. The battery group includes a set of output terminals, the output terminals operatively coupled to terminals of the battery module, the output terminals positioned on a rear face of the carrier tray.

The present disclosure also provides for a method. The method includes providing a battery group. The battery group includes a carrier tray, the carrier tray including an upper rail mount, the upper rail mount adapted to be received by a mounting bracket. The battery group includes a battery module, the battery module coupled to the carrier tray. The battery group includes a set of output terminals, the output terminals operatively coupled to terminals of the battery module, the output terminals positioned on a rear face of the carrier tray. The method further includes engaging the upper rail mount to a mounting rail of a cabinet or other enclosure; sliding the battery group along the mounting rail into the cabinet or other enclosure; and engaging the output terminals to an electrical system of the cabinet or other enclosure by sliding the battery group fully into the cabinet or other enclosure.

### BRIEF DESCRIPTION OF THE DRAWINGS

The present disclosure is best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion.

FIG. 1 is a perspective view of a battery group consistent with at least one embodiment of the present disclosure.

FIG. 2 is a perspective view of the back of the battery group of FIG. 1.

FIG. 3 is a perspective cross section view of a battery module consistent with at least one embodiment of the present disclosure.

### DETAILED DESCRIPTION

It is to be understood that the following disclosure provides many different embodiments, or examples, for implementing different features of various embodiments. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

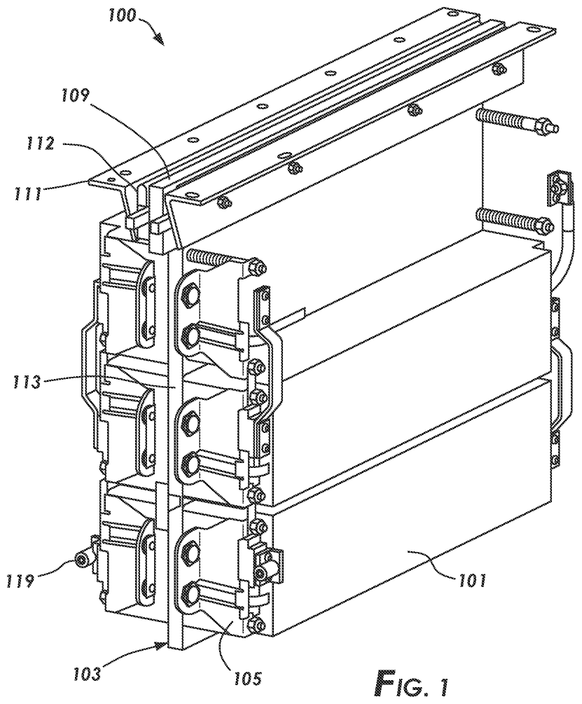

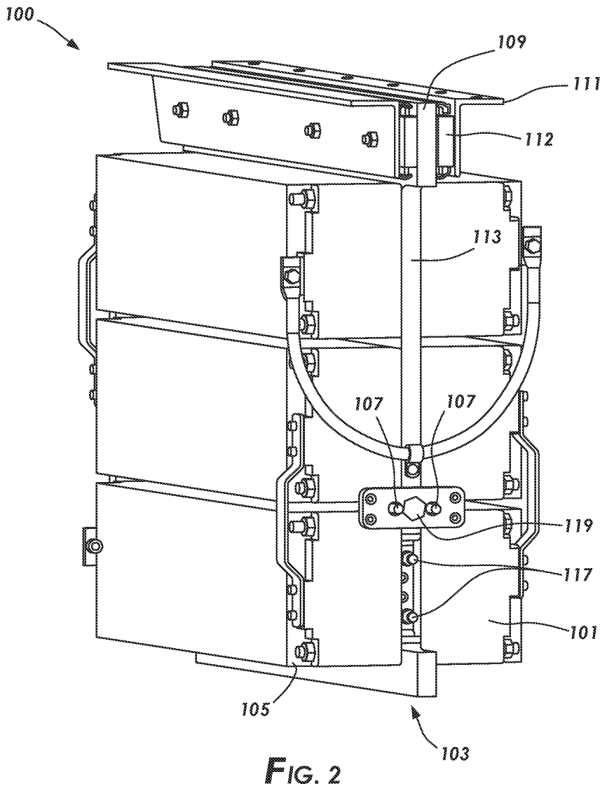

FIGS. 1-3 depict battery group 100. Battery group 100 may include one or more battery modules 101. Battery modules 101 may couple to carrier tray 103 using mechanical fasteners 105. Mechanical fasteners 105 may include one or more of, for example and without limitation, mechanical fasteners, brackets, latches, clamps, or combinations thereof. Battery group 100 is depicted as having six battery modules 101 (with one removed for clarity) but may have any number of battery modules 101 without deviating from the scope of this disclosure. In some embodiments, the terminals of battery modules 101 may be operatively coupled in series and/or in parallel such that battery group 100 operates as a single unit with a single set of output terminals 107 (shown in FIG. 2) as further described herein below. In some embodiments, output terminals 107 may be positioned at a rear face of battery group 100. In other embodiments, output terminals 107 may be positioned at the front face or on the top or side faces of battery group 100.

In some embodiments, carrier tray 103 may include upper rail mount 109. Upper rail mount 109 may couple to carrier tray 103 and may allow battery group 100 to couple to mounting bracket 111. Mounting bracket 111 may be mechanically coupled to a cabinet or other enclosure used to contain battery group 100. In some embodiments, the cabinet or other enclosure may include a plurality of mounting brackets 111 adapted to allow multiple corresponding battery groups 100 to be positioned therein. In some embodiments, upper rail mount 109 may couple to mounting bracket 111 by one or more slide rails 112.

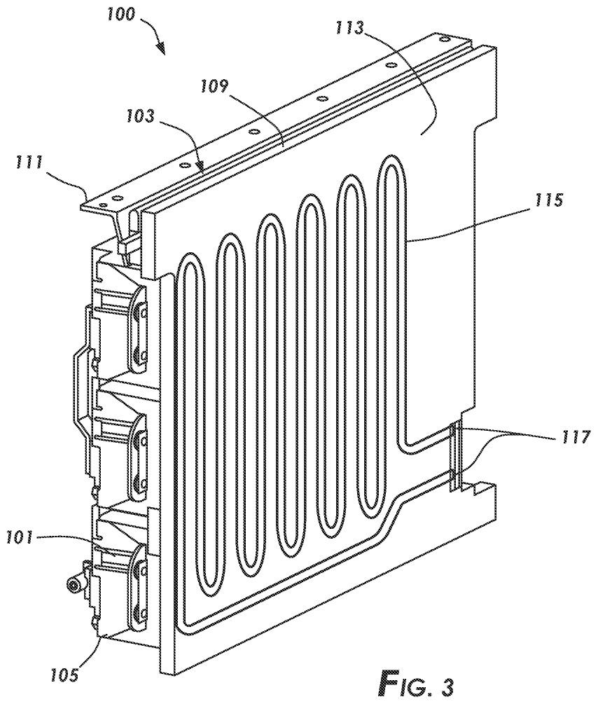

In some embodiments, carrier tray 103 may include cooling plate 113. Cooling plate 113 may be positioned along carrier tray 103 and may be positioned in contact with battery modules 101. The interface between the battery modules 101 and the cooling plate may include thermally conductive filler material, such as, for example, thermal paste, thermal gap pads, thermally conductive adhesive (which can also be used in place of mechanical mounting of battery modules 101). In certain embodiments, such an interface may improve cooling efficiency of cooling plate 113. Cooling plate 113 may include one or more coolant tubes 115 (shown most clearly in FIG. 3) passing therethrough to allow coolant from a coolant circuit of an external coolant system to flow through battery group 100 and remove heat from battery modules 101. Coolant tubes 115 may terminate at coolant couplers 117 positioned on the rear face of carrier tray and battery group 100 as shown in FIG. 2. In some embodiments, cooling plate 113 may operate as a heatsink and may be formed from aluminum or other similarly conductive metals or ceramics. In some embodiments, coolant tubes 115 may be formed from copper, and may be bonded to cooling plate 113 with thermally conductive epoxy. In other embodiments, a high contact copper press may be used to form cooling plate 113 wherein copper is pressed into a formed or machined channel to ensure that air gap is minimized, and any remaining gap is filled with thermally conductive filler material. A copper interface block may then be soldered to the pressed in copper tubing to allow for an interface to the copper tubing.

In some embodiments, output terminals 107 and coolant couplers 117 may be positioned such that they engage with and operatively couple to corresponding receptacles when inserted into the cabinet or other enclosure along mounting bracket 111. In such an embodiment, electrical and cooling connections between battery group 100 and the electrical and cooling systems of the cabinet or other enclosure may be automatically connected and disconnected when battery module 101 is installed and uninstalled, respectively, therefrom using upper rail mount 109 and slide rails 112. Such automatic connections may, for example and without limitation, simplify the process of removing battery group 100 by avoiding the need for manual electrical and cooling connections.

In some embodiments, as battery group 100 is removed from the cabinet or other enclosure and output terminals 107 disengage the corresponding receptacles, the DC bus voltage potential of battery group 100 may be reduced to a nominal value of a single battery module 101. In such an embodiment, because the voltages are lower than bus voltages encountered within the larger system into which battery group 100 is installed, safety for service personnel may be increased. Additionally, regulatory requirements relating to high voltage systems (such as PPE requirements for arc flashes) may be avoided by insulating service personnel from the high voltages as soon as battery group 100 is removed from the larger system.

In some embodiments, with reference to FIG. 2, battery group 100 may include one or more communication terminals 119 positioned on the rear of battery group 100. Communication terminals 119 may, for example and without limitation, be used to output operational properties of battery modules 101 to an external system. Operational properties may include, for example and without limitation, battery temperature, cell voltages, charge states, etc. In some embodiments, communication terminals 119 may operate at a voltage of less than 50 volts, such as 12 volts or 24 volts.

The foregoing outlines features of several embodiments so that a person of ordinary skill in the art may better understand the aspects of the present disclosure. Such features may be replaced by any one of numerous equivalent alternatives, only some of which are disclosed herein. One of ordinary skill in the art should appreciate that they may readily use the present disclosure as a basis for designing or modifying other processes and structures for carrying out the same purposes and/or achieving the same advantages of the embodiments introduced herein. One of ordinary skill in the art should also realize that such equivalent constructions do not depart from the spirit and scope of the present disclosure and that they may make various changes, substitutions, and alterations herein without departing from the spirit and scope of the present disclosure.

1. A battery group comprising:
a carrier tray, the carrier tray including an upper rail mount, the upper rail mount adapted to be received by a mounting bracket;
a battery module, the battery module coupled to the carrier tray; and
a set of output terminals, the output terminals operatively coupled to terminals of the battery module, the output terminals positioned on a rear face of the carrier tray.

2. The battery group of claim 1, wherein the carrier tray further comprises a cooling plate and a coolant tube, the coolant tube coupled to the cooling plate, the cooling plate abutting the battery module.

3. The battery group of claim 2, further comprising coolant couplers coupled to the coolant tube, the coolant couplers positioned on the rear face of the carrier tray.

4. The battery group of claim 1, further comprising a second battery module, wherein the first and second battery modules are coupled in parallel or in series.

5. The battery group of claim 1, wherein the battery module is coupled to the carrier tray by one or more mechanical fasteners.

6. The battery group of claim 1, further comprising a communication terminal positioned on a front face of the carrier tray.

7. A method comprising:
providing a battery group, the battery group including:
a carrier tray, the carrier tray including an upper rail mount;
a battery module, the battery module coupled to the carrier tray; and
a set of output terminals, the output terminals operatively coupled to terminals of the battery module, the output terminals positioned on a rear face of the carrier tray;
engaging the upper rail mount to a mounting rail of a cabinet or other enclosure;
sliding the battery group along the mounting rail into the cabinet or other enclosure; and
engaging the output terminals to an electrical system of the cabinet or other enclosure by sliding the battery group fully into the cabinet or other enclosure.

8. The method of claim 7, wherein the carrier tray further comprises a cooling plate and a coolant tube, the coolant tube coupled to the cooling plate, the cooling plate abutting the battery module, the coolant tube coupled to coolant couplers positioned on the rear face of the carrier tray, wherein the method further comprises engaging the coolant couplers with a coolant system of the cabinet or other enclosure by sliding the battery group fully into the cabinet or other enclosure.
